(19) United States
(12) Patent Application Publication
(10) Pub. No.: US 2025/0225978 A1
(43) Pub. Date: Jul. 10, 2025

(54) METHOD AND APPARATUS FOR PERSONALIZING SPEECH RECOGNITION USING ARTIFICIAL INTELLIGENCE

(71) Applicant: IUCF-HYU(INDUSTRY-UNIVERSITY COOPERATION FOUNDATION HANYANG UNIVERSITY), Seoul (KR)

(72) Inventors: JoonHyuk CHANG, Seoul (KR); DongHyun KIM, Seoul (KR); JaeHong LEE, Seoul (KR)

(73) Assignee: IUCF-HYU(INDUSTRY-UNIVERSITY COOPERATION FOUNDATION HANYANG UNIVERSITY), Seoul (KR)

(21) Appl. No.: 19/013,552

(22) Filed: Jan. 8, 2025

(30) Foreign Application Priority Data
Jan. 8, 2024 (KR) 10-2024-0002875

(51) Int. Cl. G10L 15/06; G10L 15/26; G10L 25/30

(52) U.S. Cl. CPC G10L 15/063; G10L 15/26; G10L 25/30

(57) ABSTRACT

A method performed by an electronic device using artificial intelligence according to an embodiment of the present disclosure, the method includes receiving a speech signal; and generating a text corresponding to the speech signal by using the speech signal as input in a pre-trained first artificial intelligence algorithm model, wherein the first artificial intelligence algorithm model including a first model parameter outputs a first predicted text by using a synthetic speech and a reference text as input, extracts a first loss based on the first predicted text and the reference text, and performs a first pre-training based on the first loss, wherein the first artificial intelligence algorithm model that performed the first pre-training includes a second model parameter, wherein the first artificial intelligence algorithm model that performed the first pre-training outputs a second predicted text by using the synthetic speech and the reference text as input, and extracts a second loss based on the second predicted text and the reference text, wherein the electronic device determines a loss rate which is a ratio of the first loss and the second loss, determines an adaptation parameter based on the second model parameter and the second loss if the loss rate is below a threshold value, and determines a third model parameter based on the adaptation parameter and the second model parameter, wherein the first artificial intelligence algorithm model is repeatedly pre-trained such that the first artificial intelligence algorithm model that performed a second pre-training is configured to include the third model parameter.

### CROSS-REFERENCE TO RELATED APPLICATIONS

This application claims the benefits of Korean Patent Application No. 10-2024-0002875, filed on Jan. 8, 2024, in the Korean Intellectual Property Office, the disclosures of which are incorporated herein in their entireties by reference.

### BACKGROUND

### 1. Field

The disclosure describes a method and an apparatus for personalizing a speech recognizer using artificial intelligence.

### 2. Description of the Related Art

The disclosure relates to a method and an apparatus for personalizing a speech recognizer using artificial intelligence.

Recently, a speech recognition technology that collects and processes speech signals into data, has been emerging. The speech recognition technology refers to a technology that allows a program to process human speech into text format. A speech recognition program can understand and process a speaker's grammar, syntax, and structure.

The speech recognition technology, also known as a Speech-to-Text (STT), processes speech signals generated by utterances into text data. With this technology, speech has become a novel input method for devices, enabling applications in various fields such as device control and information search via speech. Recently, with the advancement of deep learning-based machine learning technology, research on end-to-end speech recognition technology, which directly recognizes text such as words and sentences from speech data without analyzing pronunciation from speech data using acoustic models composed of deep neural networks, is actively being conducted.

Currently, automatic speech recognition (ASR) models are being generated by learning massive parameters through large amounts of data. These speech recognition models show performance for various domains and individual voices, and there are aspects that make it easy to specialize for individuals. Accordingly, personalization of ASR models is an emerging research topic in the current industry, and there is particular interest in personalization using text-only data in a form that can maximize the protection of personal information.

Speech recognition models need to be trained with speech-text pair data, for which data is generated using a speech synthesizer. However, when personalizing a speech recognizer with data generated by the speech synthesizer, there are problems of overfitting and excessive adaptation.

### SUMMARY

Provided are a method and apparatus for personalizing a speech recognition system.

Provided are a method to efficiently perform domain adaptation to enhance the performance of personalized speech recognition systems.

According to an embodiment of the disclosure, a method performed by an electronic device using artificial intelligence, includes: receiving a speech signal; and generating a text corresponding to the speech signal by using the speech signal as input in a pre-trained first artificial intelligence algorithm model, wherein the first artificial intelligence algorithm model including a first model parameter outputs a first predicted text by using a synthetic speech and a reference text as input, extracts a first loss based on the first predicted text and the reference text, and performs a first pre-training based on the first loss, wherein the first artificial intelligence algorithm model that performed the first pre-training includes a second model parameter, wherein the first artificial intelligence algorithm model that performed the first pre-training outputs a second predicted text by using the synthetic speech and the reference text as input, and extracts a second loss based on the second predicted text and the reference text, wherein the electronic device determines a loss rate which is a ratio of the first loss and the second loss, determines an adaptation parameter based on the second model parameter and the second loss if the loss rate is below a threshold value, and determines a third model parameter based on the adaptation parameter and the second model parameter, wherein the first artificial intelligence algorithm model is repeatedly pre-trained such that the first artificial intelligence algorithm model that performed a second pre-training is configured to include the third model parameter.

In an embodiment, the electronic device may be configured to determine the third model parameter as the second model parameter if the loss rate is greater than the threshold value.

In an embodiment, the pre-trained first artificial intelligence algorithm model may include a speech encoder, a prediction network, and a joint network, and the speech encoder may be a pre-trained artificial intelligence algorithm model through a self-supervised learning method with non-transcribed speech data.

In an embodiment, the speech encoder may include a structure of a “data2vec” model.

In an embodiment, the speech encoder may include a convolutional neural network (CNN), transformer lower blocks and transformer upper blocks, and parameters of the CNN and the transformer lower blocks may be fixed constantly.

In an embodiment, the prediction network may include a convolutional neural network (CNN) and an embedding layer, and a parameter of the embedding layer may be fixed constantly.

In an embodiment, the threshold value may be 1+r, where T may be a hyperparameter and may be determined as a fixed value.

In an embodiment, the synthetic speech may be generated by being synthesized in a second artificial intelligence algorithm model based on the reference text.

According to an embodiment of the disclosure, an electronic device includes: a memory; a modem; and a processor connected to the modem and the memory, wherein the processor is configured to: receive a speech signal; generate text corresponding to the speech signal by using the speech signal as input in a pre-trained first artificial intelligence algorithm model, wherein the first artificial intelligence algorithm model including a first model parameter outputs a first predicted text by using a synthetic speech and a reference text as input, extracts a first loss based on the first predicted text and the reference text, and performs a first pre-training based on the first loss, wherein the first artificial intelligence algorithm model that performed the first pre-training includes a second model parameter, wherein the first artificial intelligence algorithm model that performed the first pre-training outputs a second predicted text by using the synthetic speech and the reference text as input, and extracts a second loss based on the second predicted text and the reference text, wherein the processor determines a loss rate, which is a ratio of the first loss and the second loss, determines an adaptation parameter based on the second model parameter and the second loss if the loss rate is below a threshold value, and determines a third model parameter based on the adaptation parameter and the second model parameter, wherein the first artificial intelligence algorithm model is repeatedly pre-trained such that the first artificial intelligence algorithm model that performed a second pre-training is configured to include the third model parameter.

According to an embodiment of the disclosure, a program stored in a medium for recognizing a speech through an artificial intelligence algorithm executable by a processor, includes: receiving a speech signal; generating a text corresponding to the speech signal by using the speech signal as input into a pre-trained first artificial intelligence algorithm model, wherein the first artificial intelligence algorithm model including a first model parameter outputs a first predicted text by using synthetic speech and reference text as input, extracts a first loss based on the first predicted text and the reference text, and performs a first pre-training based on the first loss, wherein the first artificial intelligence algorithm model that performed the first pre-training includes a second model parameter, wherein the first artificial intelligence algorithm model that performed the first pre-training outputs a second predicted text by using the synthetic speech and the reference text as input, and extracts a second loss based on the second predicted text and the reference text, wherein the processor determines a loss rate, which is the ratio of the first loss and the second loss, determines an adaptation parameter based on the second model parameter and the second loss if the loss rate is below a threshold value, and determines a third model parameter based on the adaptation parameter and the second model parameter, wherein the first artificial intelligence algorithm model is repeatedly pre-trained such that the first artificial intelligence algorithm model that performed a second pre-training is configured to include the third model parameter.

According to an embodiment of the disclosure, a speech recognition model may be personalized while maintaining its performance.

According to an embodiment of the disclosure, it is possible to prevent personal information leakage that may occur during personalization and reduce excessive computational cost issues associated with training.

### BRIEF DESCRIPTION OF THE DRAWINGS

Embodiments of the disclosure will be more clearly understood from the following detailed description taken in conjunction with the accompanying drawings in which:

FIG. 1 is a conceptual diagram illustrating basic principles of an artificial intelligence architecture according to an embodiment of the disclosure.

FIG. 2 is a diagram illustrating an architecture of a transducer model according to an embodiment of the disclosure.

FIG. 3 is a diagram illustrating a model parameter update method of a speech recognition device according to an embodiment of the disclosure.

FIG. 4 is a detailed diagram illustrating a process of a training technique according to an embodiment of the disclosure.

FIG. 5 is a block configuration diagram of an electronic device to which an artificial intelligence algorithm model is applied according to an embodiment of the disclosure.

FIG. 6 is a flowchart for explaining a method of performing speech recognition according to an embodiment of the disclosure.

### DETAILED DESCRIPTION

The disclosure may be variously modified and have various embodiments, so that specific embodiments will be illustrated in the drawings and described in the detailed description. However, this does not limit the disclosure to specific embodiments, and it should be understood that the disclosure covers all the modifications, equivalents and replacements included within the inventive concept of the disclosure.

In explaining the disclosure, in the following description, a detailed description of known related technologies may be omitted to avoid unnecessarily obscuring the subject matter of the disclosure. In addition, numerals (e.g., first, second, etc.) used during describing the disclosure are merely identification symbols for distinguishing one component from another component.

Further, in the disclosure, if it is described that one component is “connected” or “accesses” the other component, it is understood that the one component may be directly connected to or may directly access the other component but unless explicitly described to the contrary, another component may be “connected” or “access” between the components.

In addition, terms including “unit”, “er”, “or”, “module”, or the like disclosed in the disclosure mean a unit that processes at least one function or operation and this may be implemented by hardware or software such as a processor, a micro processor, a micro controller, a central processing unit (CPU), a graphics processing unit (GPU), an accelerated Processing unit (APU), a digital signal processor (DSP), an application specific integrated circuit (ASIC), and a field programmable gate array (FPGA) or a combination of hardware and software, this also may be implemented in a form that is combined with memory which stores data necessary for processing at least one function or operation.

Moreover, it is intended to clarify that components in the disclosure are distinguished in terms of primary functions of the components. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

In the description of the embodiments, certain detailed explanations of a related function or configuration are omitted when it is deemed that they may unnecessarily obscure the essence of the disclosure. In addition, the terms described below are defined in consideration of the functions in the disclosure, and may vary depending on the intention or custom of a user or an operator. Therefore, the definition needs to be made based on content throughout this specification.

For the same reason, some components may be exaggerated, omitted, or schematically shown in the accompanying drawings. In addition, the size of each component does not entirely reflect its actual size. In each drawing, identical or corresponding components are given the same reference numerals.

The advantages and features of the disclosure and a method of achieving them will become clear by referring to the embodiments described in detail below along with the accompanying drawings. However, the disclosure is not limited to the embodiments disclosed below, but may be implemented in various different forms. The embodiments are provided to ensure that the description of the disclosure is complete and to fully inform one of ordinary skill in the art of the scope of the disclosure, and the claimed scope of the disclosure is only defined by the scope of the claims.

At this time, it will be understood that each block of processing flow charts and combinations of the processing flow charts may be performed by computer program instructions. Because these computer program instructions may be mounted on a processor of a general-purpose computer, special-purpose computer, or other programmable data processing equipment, the instructions performed through the processor of the computer or other programmable data processing device creates a unit to perform functions described in flow chart block(s). These computer program instructions may also be stored in computer-usable or computer-readable memory that can be directed to a computer or other programmable data processing equipment to implement the functions in a particular manner. Accordingly, the instructions stored in the computer-usable or computer-readable memory may also produce manufactured items containing an instruction unit that performs the functions described in the flow chart block(s). Because the computer program instructions can be mounted on a computer or other programmable data processing equipment, instructions that execute a computer or other programmable data processing equipment by performing a series of operations on a computer or other programmable data processing equipment to generate a computer-executable process may also provide operations for executing the functions described in the flow chart block(s).

In addition, each block may represent a module, segment, or portion of code containing one or more executable instructions for executing specified logical function(s). In addition, in some Alternative implementations, it is possible for functions mentioned in the blocks to occur out of order. For example, two blocks shown in succession may be performed substantially simultaneously, or the blocks may sometimes be performed in reverse order depending on their corresponding functions.

The term “unit or part” used in the disclosure refers to software or hardware components such as a field-programmable gate array (FPGA) or an application specific integrated circuit (ASIC), and the “unit or part” may be configured to perform specific roles. However, the “unit or part” is not limited to software or hardware. The “unit or part” may be configured to be stored in an addressable storing medium or to execute one or more processors. Accordingly, the “unit or part” may include, for example, software components, object-oriented software components, components such as class components and task components, processors, formulas, attributes, procedures, subroutines, segments of program code, drivers, firmware, micro code, circuits, data, database, data structures, tables, arrays and variables. Functions provided in components and “units or parts” may be combined into a smaller number of components and “units or parts”, or may be further divided into additional components and “units or parts.” Furthermore, components and “units or parts” may be implemented to reproduce one or more central processing units within a device or a secure multimedia card. In addition, in an embodiment, “unit or part” may include one or more processors and/or devices.

Hereinafter, embodiments according to the inventive concept of the disclosure will be described in detail in order.

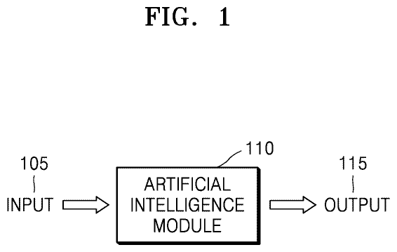

FIG. 1 is a conceptual diagram illustrating the basic principles of an artificial intelligence architecture according to an embodiment of the disclosure.

Referring to FIG. 1, a basic principle of learning performed in an artificial intelligence architecture is shown. Artificial intelligence technology represents technology for solving cognitive problems primarily associated with human intelligence, such as learning, problem-solving, and recognition. Artificial intelligence may be trained through machine learning (ML) and deep learning (DL). Machine learning is primarily used for techniques involving pattern recognition and learning, and it represents algorithms that learn by itself from data without relying on predefined rules or patterns. In contrast, deep learning is a field of machine learning with the difference that it processes data based on Artificial Neural Networks (ANN). Deep learning can process more complex and sophisticated computations than machine learning because it uses artificial neural networks. Types of algorithms for deep learning may include Convolutional Neural Networks (CNN), Artificial Neural Networks (ANN), Recurrent Neural Networks (RNN), and others.

Referring to FIG. 1, the artificial intelligence architecture can be represented as an artificial intelligence module 110. The artificial intelligence module 110 receives predetermined input data 105 and performs learning through a predetermined method defined within the module, then outputs output data 115 based on the result of learning. According to an embodiment, the input data 105 may include predetermined data, text data, input sequences, synthesized speech, speech data, etc. The output data 115 may include speech data, generated speech signals, text data, output sequences, etc.

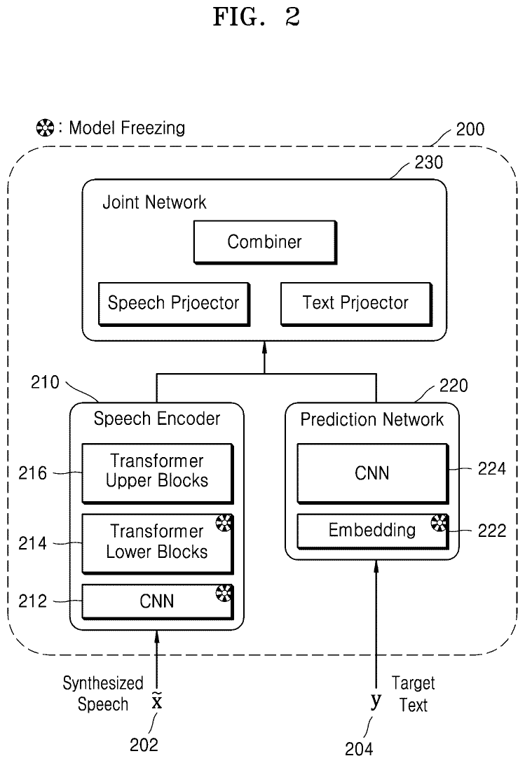

FIG. 2 is a diagram illustrating an architecture of a transducer model according to an embodiment of the disclosure.

The artificial intelligence algorithm model 200 of FIG. 2 may be one type of the artificial intelligence module 110 of FIG. 1. In an embodiment, the artificial intelligence algorithm model 200 may use a neural transducer speech recognition model as a baseline. The neural transducer speech recognition model (hereinafter referred to as the neural transducer) may have a model architecture consisting of three components: an encoder, a prediction network, and a joint network.

The neural transducer is a structure designed to solve sequence-to-sequence problems due to the mismatch in length between speech and text sequences.

Referring to FIG. 2, the artificial intelligence algorithm model 200 may include a speech encoder 210, a prediction network 220, and a joint network 230.

The speech encoder 210 may include a CNN 212, transformer lower blocks 214, and transformer upper blocks 216. The speech encoder 210 may perform the role of converting speech data into embedding vectors.

The prediction network 220 may include an embedding layer 222 and a CNN 224. The prediction network 220 may perform the role of converting text data into embedding vectors.

The joint network 230 may include a speech projector, a text projector, a combiner, or the like. The joint network 230 may receive and process embedding vectors from the speech encoder 210 and the prediction network 220, and output a combined matrix.

According to an embodiment, the speech encoder 210 may use a “data2vec” model. “data2vec” (hereinafter referred to as D2V) can be pre-trained through self-supervised loss using large amounts of unlabeled data. D2V is trained by reducing the Euclidean distance between an output of the model being trained and an output of an exponential moving average (EMA) teacher model when receiving unlabeled speech as input, and the loss used for training may be as shown in Equation 1.

$$L ( {y}_{t} , {f}_{t} ( x ) ) = \{ \begin{matrix}\frac{1}{2} {( {y}_{t} - {f}_{t} ( x ) )}^{2} / β & \vert ( {y}_{t} - {f}_{t} ( x ) ) \vert \leq β \\ ( \vert {y}_{t} - {f}_{t} ( x ) \vert - \frac{1}{2} β ) & otherwise\end{matrix} \qquad [ Equation 1 ]$$

The model trained through the self-supervised learning method as described above is robust against domain shifts, and then has an effect of being more suitable for personalization.

By utilizing the neural transducer architecture, the artificial intelligence algorithm model 200 may compute transducer loss and, based on this, find the optimal speech-text alignment, allowing for mapping of two different sequences.

Conventional neural transducer-based speech recognition models show good performance in various environments due to learning a large number of parameters using massive amounts of data. However, when applied to specific domains or personalization, they have shown performance that is inferior to small models. This is because the model extracts overly generalized vectors as it learns common information across large amounts of data. Therefore, research continues on adapting models to specific domains to address this issue. Hereinafter, focusing on text-only personalization technology, a technique is proposed to efficiently handle potential overfitting problems when utilizing synthetic data.

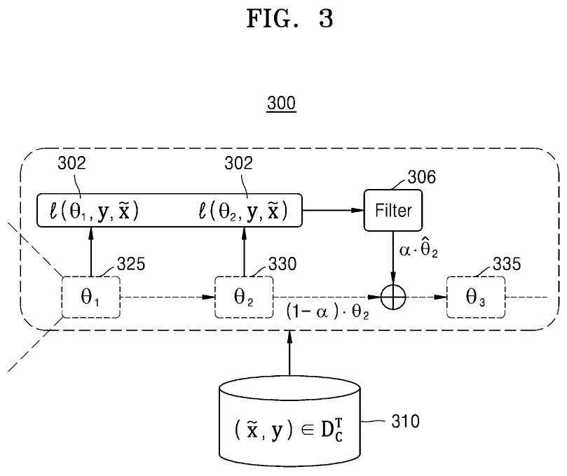

FIG. 3 is a diagram illustrating a model parameter update method of a speech recognition device according to an embodiment of the disclosure.

FIG. 3 is for explaining a method for personalizing a speech recognition device, targeting a speech recognizer as a special case of domain adaptation where the focus of a target domain is on individuals. Domain adaptation refers to a method of adapting an artificial intelligence model to a target domain using data from a specific domain. Domain adaptation is generally performed through supervised learning and may be calculated as shown in Equation 2.

$$R ( θ , {D}^{T} ) = \int {p}_{T} ( x , y ) l ( θ , y , x ) dxdy \approx \frac{1}{{N}_{T}} {\sum }_{( {x}_{n} , {y}_{n} ) ∈ {D}^{T}} l ( θ , {y}_{n} , {x}_{n} ) \qquad [ Equation 2 ]$$

Here, R(θ,D^{T}) is referred to as empirical risk, θ refers to a model parameter,

D^{T}={(xₙ,yₙ)˜p_{T}:n=1:N_{T}}

refers to N_{T} of target domain data, p_{T} refers to the probability distribution of the target domain, x refers to speech, y refers to text, and 1 refers to a loss function that may represent the target function.

The personalization of speech recognizers using text-only data corresponds to the field of text-only domain adaptation among domain adaptations, and this may aim for domain adaptation in a state where target domain data is incomplete. Here, assuming the absence of text y, the incomplete target domain data can be represented as

D_{IC}^{T}={yₙ˜p_{T}:n=1:N_{T}}.

That is, the personalization method using text-only data is applying text-only domain adaptation technology to individual target domains according to each person.

The disclosure proposes a text-only unsupervised domain adaptation method (ToUDA). Conventional models often utilize a method of synthesizing speech data

[symbol]

˜q_{θ}(x|yₙ)

using a TTS model to convert incomplete target domain data D_{IC}^{T} to complete data

D_{C}^{T}={( [symbol] ,yₙ)˜p_{T}:n=1:N_{T}}.

However, when adapting to the target domain using speech data synthesized in this manner, phenomena such as model over-adaptation (overfitting) due to the quantity of target domain data, and negative learning effects (out-of-distribution samples) due to feature vectors different from real data, such as noise and mechanical sounds included in the synthetic data, occurred. Thus, the ToUDA method proposed in the disclosure aims to solve these problems by utilizing “foundation model,” “parameter regularization,” and “data filtering” techniques. The overall framework of the ToUDA method is as shown in FIG. 3.

First, the foundation model may refer to a pre-trained model using self-supervised learning method with a large amount of non-transcribed speech data. Generally, as they are trained using labeled data and task-specific losses, both unlabeled data and labeled data may be utilized. For example, the data2vec model described in FIG. 2 may correspond to this. The foundation model extracts simple feature vectors from raw speech, and these simple feature vectors may be extracted in a form that maximally excludes noise information. The strength of such foundation model is that it can be utilized for personalization by making it easier to identify the characteristics of target domain data while simultaneously preventing overfitting problems to noise.

Second, the parameter regularization is a method using Exponential Moving Average (EMA) and model freezing. The EMA is a method of obtaining new model parameters by using EMA between model parameters before domain adaptation and model parameters after adaptation, and may be obtained as shown in Equation 3.

$${θ}_{l + 1} = α \cdot {\hat{θ}}_{l} + ( 1 - α ) \cdot {θ}_{l} \qquad [ Equation 3 ]$$

Here, 1={1, . . . , L} refers to the learning steps, and a refers to a hyperparameter as EMA decay parameter. Equation 2 may adjust the trade-off between personalization performance and overfitting problem through a convex combination between model parameters before adaptation and model parameters after adaptation. While EMA suggests that model parameters changed through the domain adaptation process do not significantly change from the existing parameters, the model freezing method may be a way to completely fix certain model parameters so they do not change at all. Specifically, due to the characteristics of the foundation model, it is possible to suppress the model from adapting to information such as noise and mechanical sounds inherent in synthetic data by restricting lower layers, where acoustic information can change significantly, from changing.

For a detailed explanation, referring to FIG. 2, synthesized speech 202 and text data 204 (or target text) may be input into the artificial intelligence algorithm model 200. The synthesized speech 202 may be input to the artificial intelligence algorithm model 200 and then input to the speech encoder 210. Here, through the model freezing method of parameter regularization, the speech encoder 210 may fix parameters of the CNN 212 and the transformer lower blocks 214 that process the synthesized speech data. By fixing parameters of lower layers of the speech encoder 210, it is possible to limit and prevent domain overfitting and negative learning effects (out-of-distribution sample) adaptation for synthesized speech. The text data 204 may be input to the artificial intelligence algorithm model 200 and then input to the prediction network 220. Parameters of the embedding layer 222 of the prediction network 220 may be fixed.

Finally, the data filtering may represent a method of detecting learning adverse effects (out-of-distribution samples) that may manifest in synthesized data and excluding them from learning. The learning adverse effects can refer to cases where acoustic information that is not similar to the voice of the target individual is inherent in the synthesized data due to noise, random speaker information, etc., that may occur in the synthesized data. When the data filtering is applied, a model parameter update equation may be as shown in Equation 4.

$${\hat{θ}}_{l} = {θ}_{l} - η ∇ ( \frac{1}{\vert {D}_{l} \vert} l ( {θ}_{l} , {y}_{n} , ) ) \qquad [ Equation 4 ]$$

Here, Dₜ represents dataset used in 1-th learning step and may be a result of filtering out learning adverse samples from an entire dataset D. That is, the composition of data used may vary at each learning step. The adaptation parameter \tilde{θ}ₗ obtained through this method may be utilized in Equation 3.

The data filtering, with its key point being to effectively obtain the filtered dataset Dᵢ, may automatically filter out data that adversely affects learning based on a loss-ratio. The data filtering method applied in the disclosure, there is no need for hyperparameters that must be preset individually for each person in personalization, and it has the characteristic of not utilizing the voice of the target speaker at all. This method is referred to a loss ratio-driven data filtering (LRDF), and the calculation for obtaining the filtered dataset can be as shown in Equation 5.

$${D}_{l} = \{ ( , {y}_{n} ) ϵ {D}_{C}^{T} \vert \frac{l ( {θ}_{l} , {y}_{n} , \tilde{{x}_{n}} )}{l ( {θ}_{l - 1} , {y}_{n} , \tilde{{x}_{n}} )} \leq 1 + τ \} \qquad [ Equation 5 ]$$

The LRDF is a mechanism that reflects the assumption that a loss generated through model parameters of a previous training step should be higher than a loss generated through model parameters after domain adaptation. That is, if the loss generated in the model adapted to the target domain is measured to be higher, the corresponding data may be treated as a learning adverse effect sample. τ is a hyperparameter to adjust data filtering sensitivity and may be set to a very small value. For example, τ may have a value of 0.017. τ may be used as a fixed value for all individuals that need to be adapted.

In LRDF, when model parameter θ is learned through updates from 1=1 to L updates, a model parameter trained 1 times may be referred to as θₗ. If transducer loss l(θ,y,x) generated from the synthesized speech data×and corresponding target text data y is higher than l(θᵢ₋₁,y,x) generated from the model parameters of the previous training step, then the data pair (x, y) may be excluded from training.

The LRDF has differences from conventional data filtering methods. First, techniques that remove data when the loss incurred for a specific sample is higher than a predetermined threshold have the problem of being very sensitive to the threshold hyperparameter, making them difficult to use in the personalization process for multiple individual speakers. However, the data filtering method of this disclosure has solved this issue. Next, techniques that measure how similar synthesized speech is to the actual target speaker's voice and filter out dissimilar data require reference voices of all target speakers in advance, making practical application difficult, whereas the data filtering method has high applicability as it does not require reference speakers.

Referring to FIG. 3, it shows a model parameter update method to which the three methods proposed in the disclosure are applied. The architecture of FIG. 3 may represent an electronic device 300 including an artificial intelligence algorithm model. The model parameter may be updated using a complete dataset 310 that includes synthesized speech data (\tilde{x}ₙ) and target text (y) generated through a TTS model. A first model 325 may extract a first loss 302 based on a first model parameter by using the synthesized data and target text as input. Subsequently, a second model 330 may extract a second loss 304 based on a second model parameter by using the synthesized data and target text as input. The second model 330 may represent the first model performing the next learning step. Here, the first model 325 and the second model 330 may correspond to the foundation model described earlier. That is, speech encoders of the first model 325 and the second model 330 may apply pre-trained artificial intelligence models (such as data2vec) using self-supervised learning with non-transcribed speech data. The first loss 302 and the second loss 304 extracted from the first model 325 and the second model 330, respectively, may be input into a filter 306 for data filtering.

The filter 306 utilizes the data filtering techniques to compare the first loss and the second loss obtained from the complete dataset 310 and extract an adapted parameter (\tilde{θ}₂ in FIG. 3) where the data filtering has been applied. This may be extracted using Equation 4 and Equation 5 described above. That is, the filter 306 performs the operation of filtering out learning adverse samples from the complete dataset 310. Here, a new model parameter (in this case, third model parameter, θ₃ in FIG. 3) may be obtained based on the acquired adaptation parameter and the most recently used second model parameter, and a third loss may be extracted through a third model 335 applying the third model parameter, and the complete data may be organized through a method of repeatedly performing data filtering based on the second loss and the third loss.

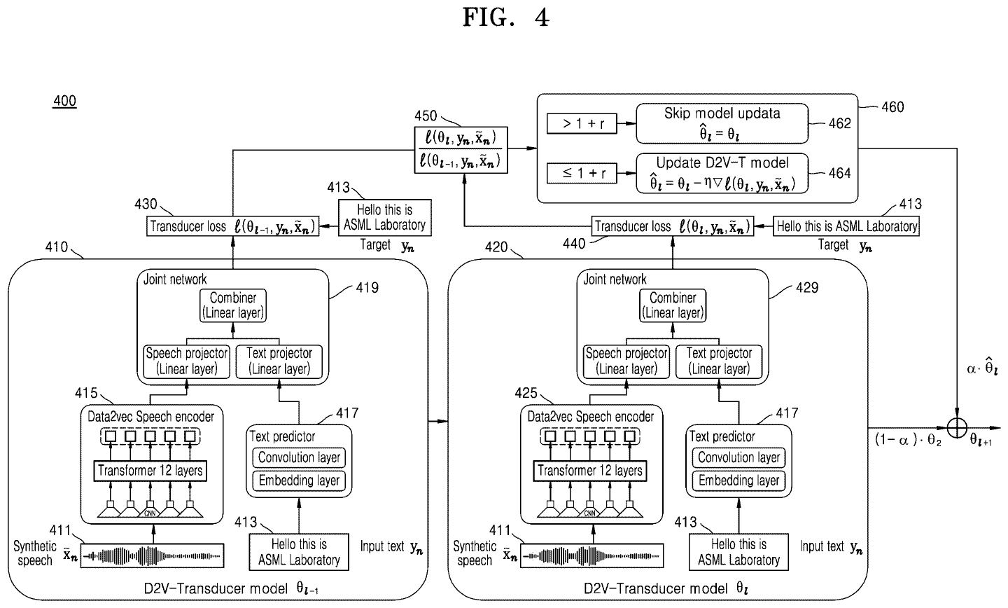

FIG. 4 is a detailed diagram illustrating a process of a training technique according to an embodiment of the disclosure.

1-ith and lth transducer models 410, 420 of FIG. 4 may be identical or similar to the speech synthesis model 200 of FIG. 2 or the first model 325 and the second model 330 of FIG. 3. 1-ith loss 430 and lth loss 440 of FIG. 4 may each be identical or similar to the first loss 302 and the second loss 304 of FIG. 3. A synthetic speech 411 and a target text 413 of FIG. 4 may be identical or similar to the synthesized speech 202 and the text data 204 of FIG. 2, or the synthesized speech data and the target text of FIG. 3. A filter 460 of FIG. 4 may be identical or similar to the filter 306 of FIG. 3.

Referring to FIG. 4, it may represent a learning method of an electronic device 400 that includes an artificial intelligence algorithm model. The electronic device 400 may include transducer models 410, 420. The transducer models 410, 420 may include a speech encoder 415, 425, prediction networks 417, 427, and joint networks 419, 429. Here, some layers of the speech encoder 415 and the prediction network 417 may have model freezing applied. For example, parameters of the CNN and the transformer lower blocks of the speech encoder 415 may be fixed, and a parameter of the embedding layer in the prediction network 417 may be fixed.

First, a synthetic speech 411 and a target text 413 may be input into the 1-1 transducer model 410. Here, the target text 413 may correspond to the synthetic speech 411. The synthetic speech 411 may be input into the speech encoder 415, and the target text 413 may be input into the prediction network 417. The 1-1 transducer model determines the 1-1 loss 430 by comparing the output result using the synthetic speech 411 and the target text 413 as inputs in the 1−1th transducer model with the target text 413.

Next, the synthetic speech 411 and the target text 413 may be input into the 1 transducer model 420. The synthetic speech 411 may be input into the speech encoder 425, and the target text 413 may be input into the prediction network 427. The 1 transducer model determines the 1 loss 440 by comparing the output result using the synthetic speech 411 and the target text 413 as inputs in the 1 transducer model with the target text 413.

A loss rate 450 may be calculated based on the determined 1-1 loss 430 and 1 loss 440. The filter 460 may determine whether to perform a model update by comparing the calculated loss rate with 1+^{τ}. If the loss rate 450 is greater than 1+^{τ}, the model update may not be performed 462. In this case, the adaptation parameter \tilde{θ}ₗ may remain the same as the 1 model parameter \tilde{θ}ₗ. If the loss rate 450 is less than or equal to 1+^{τ}, the speech encoder of the transducer model may be updated 464. Here, Equation 4 of FIG. 3 may be used to determine the adaptation parameter. Therefore, the transducer model may perform gradient backpropagation.

When the adaptation parameter is determined by the filter 460, Equation 3 of FIG. 3 may be used to determine a parameter for a 1+1 model. Based on the 1+1 model parameter, the 1+1th transducer model is constructed, and here, learning may be performed by extracting the 1+1th loss using the synthetic speech 411 and the target text 413 as inputs and repeating the previous operations.

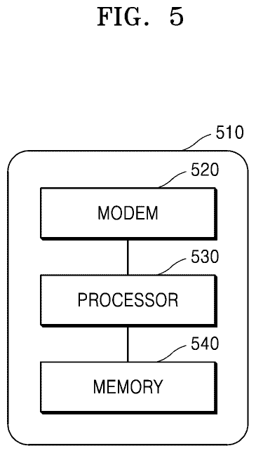

FIG. 5 is a block configuration diagram of an electronic device to which an artificial intelligence algorithm model is applied according to an embodiment of the disclosure. Referring to FIG. 5, an electronic device 510 may include a modem 520, a memory 540, and a processor 530.

The modem 520 may be a communication modem electrically connected to other electronic devices to enable mutual communication. Specifically, the modem 520 may receive data input and transmit the data to the processor 530, the processor 530 may be configured to store the received data values in the memory 540. In addition, the information output by the trained artificial intelligence algorithm in the system may be transmitted to other electronic devices.

The memory 540 is a component where various information and program instructions for an operation of the electronic device 510 are stored, and may be a storage device such as a hard disk, solid state drive (SSD), etc. Specifically, the memory 540 may store one or more data input values received from the modem 520 under the control of the processor 530. The memory 540 may also store program instructions executable by the processor 530, such as an artificial intelligence algorithm for speech recognition.

The processor 530 is composed of at least one processor and may use the data and program instructions stored in the memory 540 to calculate data using a speech recognition artificial intelligence algorithm and an artificial intelligence algorithm trained using the ToUDA method.

The processor 530 may control and compute all artificial intelligence algorithms described in FIGS. 1 to 4 (for example, speech recognition algorithm model, speech encoder, data2vec, and artificial intelligence algorithm models trained using the ToUDA method).

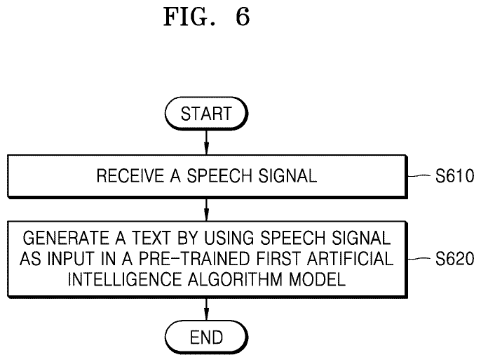

FIG. 6 is a flowchart for explaining a method of performing speech recognition according to an embodiment of the disclosure.

With reference to FIG. 6 below, the learning operations of artificial intelligence algorithms of the electronic device, speech recognition methods, and artificial intelligence algorithm learning methods through ToUDA method described with reference to FIGS. 1 to 5 are summarized and explained. Each operation is not necessarily an essential operation to be included in a series of processes, and depending on the situation, only some may be configured to operate.

In step S610, the electronic device may receive a speech signal.

In step S620, the electronic device may generate a text corresponding to the speech signal by using the speech signal as input in a pre-trained first artificial intelligence algorithm model (for example, the speech synthesis model 200 of FIG. 2, the electronic device 300 of FIG. 3, or the electronic device 400 of FIG. 4).

In an embodiment, the first artificial intelligence algorithm model (for example, the first model 325 of FIG. 3 or the 1-1 transducer model 410 of FIG. 4) may include the first model parameter. Here, the first artificial intelligence algorithm model may represent the model before pre-training.

In an embodiment, the first artificial intelligence algorithm model may output a first predicted text by using synthetic speech (for example, the synthesized speech 202 of FIG. 2, the synthesized speech data of FIG. 3, or the synthetic speech 411 of FIG. 4) and reference text (for example, the text data 204 of FIG. 2, the target text in FIG. 3, or the target text 413 in FIG. 4) as input. The first artificial intelligence algorithm model may extract a first loss (for example, the first loss 302 of FIG. 3 or the 1-1 loss 430 of FIG. 4) based on the first predicted text and the reference text, and perform a first pre-training based on the first loss.

In an embodiment, the first artificial intelligence algorithm model that performed the first pre-training (for example, the second model 330 of FIG. 3 or the lth transducer model 420 of FIG. 4) may include a second model parameter.

In an embodiment, the first artificial intelligence algorithm model that performed the first pre-training may output a second predicted text by using the synthetic speech and the reference text as input, and extract a second loss (for example, the second loss 304 of FIG. 3 or the 1 loss 440 of FIG. 4) based on the second predicted text and the reference text.

In an embodiment, the electronic device may determine a loss rate, which is a ratio of the first loss and the second loss (for example, the loss rate 450 of FIG. 4). If the loss rate is below a threshold value, the electronic device may determine an adaptation parameter based on the second model parameter and the second loss, and determine a third model parameter based on the adaptation parameter and the second model parameter.

In an embodiment, the first artificial intelligence algorithm model (for example, the third model 335 of FIG. 3) that performed a second pre-training may be repeatedly pre-trained to be configured to include the third model parameter.

In an embodiment, the electronic device may be configured to determine the third model parameter as the second model parameter if the loss rate is greater than the threshold value.

In an embodiment, the pre-trained first artificial intelligence algorithm model may include a speech encoder (for example, the speech encoder 210 of FIG. 2, the speech encoders 415, 425 of FIG. 4), a prediction network (for example, the prediction network 220 of FIG. 2, the prediction networks 417, 427 of FIG. 4), and a joint network (for example, the joint network 230 of FIG. 2, the joint networks 419, 429 of FIG. 4). The speech encoder may be a pre-trained artificial intelligence algorithm model through self-supervised learning with non-transcribed speech data.

In an embodiment, the speech encoder may include the structure of a “data2vec” model.

In an embodiment, the speech encoder may include a convolutional neural network (CNN) (for example, the CNN 212 of FIG. 2), transformer lower blocks (for example, the transformer lower blocks 214 of FIG. 2), and transformer upper blocks (for example, the transformer upper blocks 216 of FIG. 2), and a parameter of the CNN and the transformer lower blocks may be fixed constantly.

In an embodiment, the prediction network may include a convolutional neural network (CNN) (for example, the CNN 224 of FIG. 2) and an embedding layer (for example, the embedding layer 222 of FIG. 2), and a parameter of the embedding layer may be fixed constantly.

In an embodiment, the threshold value is 1+^{τ}, where τ is a hyperparameter and may be determined as a fixed value.

In an embodiment, the synthetic speech may be generated by being synthesized in a second artificial intelligence algorithm model (for example, a TTS artificial intelligence algorithm model) based on the reference text.

Although the inventive concept of the disclosure is described in detail with numerous embodiments, the inventive concept of the disclosure is not limited to the above embodiments, and various modifications and alterations are possible by those skilled in the art within the scope of the inventive concept of the disclosure.

What is claimed is:

1. A method performed by an electronic device using artificial intelligence, comprising:
receiving a speech signal; and
generating a text corresponding to the speech signal by using the speech signal as input in a pre-trained first artificial intelligence algorithm model,
wherein the first artificial intelligence algorithm model including a first model parameter outputs a first predicted text by using a synthetic speech and a reference text as input, extracts a first loss based on the first predicted text and the reference text, and performs a first pre-training based on the first loss,
wherein the first artificial intelligence algorithm model that performed the first pre-training includes a second model parameter,
wherein the first artificial intelligence algorithm model that performed the first pre-training outputs a second predicted text by using the synthetic speech and the reference text as input, and extracts a second loss based on the second predicted text and the reference text,
wherein the electronic device determines a loss rate which is a ratio of the first loss and the second loss, determines an adaptation parameter based on the second model parameter and the second loss if the loss rate is below a threshold value, and determines a third model parameter based on the adaptation parameter and the second model parameter,
wherein the first artificial intelligence algorithm model is repeatedly pre-trained such that the first artificial intelligence algorithm model that performed a second pre-training is configured to include the third model parameter.

2. The method of claim 1, wherein the electronic device is configured to determine the third model parameter as the second model parameter if the loss rate is greater than the threshold value.

3. The method of claim 1, wherein the pre-trained first artificial intelligence algorithm model includes a speech encoder, a prediction network, and a joint network, and the speech encoder is a pre-trained artificial intelligence algorithm model through a self-supervised learning method with non-transcribed speech data.

4. The method of claim 3, wherein the speech encoder includes a structure of a “data2vec” model.

5. The method of claim 3, wherein the speech encoder includes a convolutional neural network (CNN), transformer lower blocks and transformer upper blocks, and parameters of the CNN and the transformer lower blocks are fixed constantly.

6. The method of claim 3, wherein the prediction network includes a convolutional neural network (CNN) and an embedding layer, and a parameter of the embedding layer is fixed constantly.

7. The method of claim 1, wherein the threshold value is 1+τ, where τ is a hyperparameter and is determined as a fixed value.

8. The method of claim 1, wherein the synthetic speech is generated by being synthesized in a second artificial intelligence algorithm model based on the reference text.

9. An electronic device comprising:
a memory;
a modem; and
a processor connected to the modem and the memory, wherein the processor is configured to:
receive a speech signal;
generate text corresponding to the speech signal by using the speech signal as input in a pre-trained first artificial intelligence algorithm model,
wherein the first artificial intelligence algorithm model including a first model parameter outputs a first predicted text by using a synthetic speech and a reference text as input, extracts a first loss based on the first predicted text and the reference text, and performs a first pre-training based on the first loss,
wherein the first artificial intelligence algorithm model that performed the first pre-training includes a second model parameter,
wherein the first artificial intelligence algorithm model that performed the first pre-training outputs a second predicted text by using the synthetic speech and the reference text as input, and extracts a second loss based on the second predicted text and the reference text,
wherein the processor determines a loss rate, which is a ratio of the first loss and the second loss, determines an adaptation parameter based on the second model parameter and the second loss if the loss rate is below a threshold value, and determines a third model parameter based on the adaptation parameter and the second model parameter,
wherein the first artificial intelligence algorithm model is repeatedly pre-trained such that the first artificial intelligence algorithm model that performed a second pre-training is configured to include the third model parameter.

10. The electronic device of claim 9, wherein the processor is configured to determine the third model parameter as the second model parameter if the loss rate is greater than the threshold value.

11. The electronic device of claim 9, wherein the pre-trained first artificial intelligence algorithm model includes a speech encoder, a prediction network, and a joint network, and the speech encoder is a pre-trained artificial intelligence algorithm model through a self-supervised learning method with non-transcribed speech data.

12. The electronic device of claim 11, wherein the speech encoder includes a structure of a “data2vec” model.

13. The electronic device of claim 11, wherein the speech encoder includes a convolutional neural network (CNN), transformer lower blocks, and transformer lower blocks, and parameters of the CNN and the transformer upper blocks are fixed constantly.

14. The electronic device of claim 11, wherein the prediction network includes a convolutional neural network (CNN) and an embedding layer, and a parameter of the embedding layer is fixed constantly.

15. The electronic device of claim 9, wherein the threshold value is represented as 1+τ, where τ is a hyperparameter and is determined as a fixed value.

16. The electronic device of claim 9, wherein the synthetic speech is generated by being synthesized in a second artificial intelligence algorithm model based on the reference text.

17. A program stored in a medium for recognizing a speech through an artificial intelligence algorithm executable by a processor, comprising:
receiving a speech signal;
generating a text corresponding to the speech signal by using the speech signal as input into a pre-trained first artificial intelligence algorithm model,
wherein the first artificial intelligence algorithm model including a first model parameter outputs a first predicted text by using synthetic speech and reference text as input, extracts a first loss based on the first predicted text and the reference text, and performs a first pre-training based on the first loss,
wherein the first artificial intelligence algorithm model that performed the first pre-training includes a second model parameter,
wherein the first artificial intelligence algorithm model that performed the first pre-training outputs a second predicted text by using the synthetic speech and the reference text as input, and extracts a second loss based on the second predicted text and the reference text,
wherein the processor determines a loss rate, which is the ratio of the first loss and the second loss, determines an adaptation parameter based on the second model parameter and the second loss if the loss rate is below a threshold value, and determines a third model parameter based on the adaptation parameter and the second model parameter,
wherein the first artificial intelligence algorithm model is repeatedly pre-trained such that the first artificial intelligence algorithm model that performed a second pre-training is configured to include the third model parameter.
